(19) United States
(12) Patent Application Publication
(10) Pub. No.: US 2007/0008416 A1
(43) Pub. Date: Jan. 11, 2007

(54) Method and system for capture of the multi-channel image signal which can enhance the capture efficiency by deciding the unstable period of the system

(76) Inventors: Hyung Joo Kim, Seoul (KR); Jae Sool Shim, Kyunggi-do (KR); Joong Bum Yoon, Seoul (KR); Seung Il Cheong, Kwangju (JP)

Correspondence Address: LADAS & PARRY LLP, 224 SOUTH MICHIGAN AVENUE, SUITE 1600, CHICAGO, IL, 60604, US

(21) Appl. No.: 10/569,935

(22) PCT Filed: Jul. 23, 2004
(86) PCT No.: PCT/KR04/01843

§ 371 Date: Feb. 27, 2006

(30) Foreign Application Priority Data
Sep. 19, 2003 (KR) 10-2003-0065040

(51) Int. Cl. H04N 5/232

(52) U.S. Cl. 348/211.11

(57) ABSTRACT

The present invention relates to a system and method for capturing of the multi-channel image signal which can enhance capturing rate of image signals by exactly deciding the unstable period of an image capturing module capturing video data included in an image signal, wherein the system for capturing of the multi-channel image signal according to one embodiment of the present invention comprises a receiving module for receiving image signals including video data from at least one camera; a sync signal separating module for extracting sync signals indicating the existing location of video data from the image signal; an image capturing module for capturing video data of the image signal sequentially according to predetermined capturing order; a storage module for storing information about the unstable period of the image capturing module and the extracted sync signal respectively; and a decision module for selecting the sync signal of the second image signal located outside of the unstable period based on the extracted sync signal from the first image signal and the unstable period; wherein the unstable period includes the first unstable period, the predetermined period from failing edge of the sync signal extracted from the first image signal. According to the present invention, there is an advantage that it is possible to provide a system and a method for capturing of the multi-channel image signal which enhance the capture efficiency of image signals by raising the rate of capturable video data to the maximum through the exact decision of the unstable period of an image capturing module capturing video data of an image signal.

### TECHNICAL FIELD

The present invention relates to a system and method for capturing of the multi-channel image signal, and more particularly, to a system and method for capturing of the multi-channel image signal which can enhance the capture efficiency of image signals by exactly deciding the unstable period of an image capturing module capturing video data included in the image signal.

### BACKGROUND ART

Generally, an image signal capturing system is a device for receiving image signals generated by using a photographing camera from one or a plurality of channels and converting the input image signals into digital image signals by using an image processing board. Also, the image signal capturing system transmits the converted digital image signals to a display device located in a predetermined remote site or a post-processing device such as a digital video recorder (DVR), etc for indication and storage thereof.

At this time, the image signal capturing system captures the received image signals selectively according to system efficiency and importance of a place where the photographing camera is located. That is, it is necessary to capture more specified image signals prior to other image signals according to the manufacturing characteristics of the image signal capturing system receiving more than one image signal.

At this time, the image signal capturing system includes the unstable period in which the image signal capturing system cannot capture video data of other image signals in succession soon after capturing video data of the image signal according to the manufacturing characteristics thereof. Accordingly, an image signal capturing operation of the image signal capturing system inevitably has important relation with this unstable period.

However, there has been no system and method hereto which recognizes and decides the unstable period correctly. Therefore, the image signal capturing operation has been implemented on the arbitrary assumption of the unstable period according to a user's general experience. Consequently, the unstable period of the image signal capturing system may be estimated unreasonably longer than the actual time whereby there is a problem that it is impossible to recognize a sync signal located outside of the actual unstable period.

This arbitrary estimation of the unstable period yields many problems which cause loss of image signals and disconnection of screen of image signals in each channel by decreasing capturing rate of image signals remarkably through skip of capturable video data.

Accordingly, there is a need for the advent of new concept of a system and method for capturing of the multi-channel image signal which can enhance the capture efficiency of the image signal by deciding the unstable period of the system exactly.

### DISCLOSURE OF THE INVENTION

### Technical Questions

The present invention is conceived to solve the aforementioned problems. Therefore, an object of the present invention is to provide a system and method for capturing of the multi-channel image signal which can enhance capturing rate of image signals by raising the rate of capturable video data to the maximum through the exact decision of the unstable period of an image capturing module which captures video data of an image signal.

Further, another object of the present invention is to provide a system and method for capturing of the multi-channel image signal which enables video data corresponding to a sync signal under the stable state to be captured by deciding the first unstable period and the second unstable period in detail based on sync signals captured by an image capturing module and then by letting the image capturing module recognize sync signals only occurring outside of the first unstable period and the second unstable period.

Furthermore, another object of the present invention is to provide a system and a method for capturing of the multi-channel image signal which can reduce loss of video data by determining an optimal capturing order by making it possible to estimate the exact period of a sync signal through periodical updating for the sync signal of each image signal.

### Technical Solutions

In order to achieve the aforementioned objects, a system for capturing of the multi-channel image signal according to one embodiment of the present invention comprises a receiving module for receiving an image signal including video data from at least one camera; a sync signal separating module for extracting a sync signal indicating the existing location of video data from the image signal; an image capturing module for capturing video data of the image signal sequentially according to the predetermined capturing order, wherein the image signal captured according to the predetermined capturing order is a first image signal and an image signal to be captured in succession after the first image signal according to the capturing order is a second image signal; a storage module for recording information about the unstable period of the extracted sync signal and the image capturing module; and a decision module for selecting the sync signal of the second image signal located outside of the unstable period, based on the sync signal extracted from the first image signal and the unstable period, wherein the unstable period includes the predetermined period from the falling edge of the sync signal extracted from the first image signal, i.e., the first unstable period

Furthermore, as a technical embodiment in order to achieve the aforementioned objects, a method for capturing of the multi-channel image signal comprises the steps of maintaining information about a first unstable period and a second unstable period in a predetermined storage module; receiving an image signal including video data from at least one channel and extracting each sync signal from the received image signal respectively; capturing the video data corresponding to the sync signal of a first image signal according to predetermined capturing order; selecting the sync signal of a second image signal having rising edge outside of the first unstable period and the second unstable period based on falling edge of the sync signal of the first image signal; and capturing the video data corresponding to the sync signal of the second image signal; wherein the first unstable period is a predetermined period from falling edge of the sync signal extracted from the first image signal and the second unstable period is a period from a first point of time before rising edge of the next sync signal for the sync signal of the first image signal to a second point of time after rising edge.

### BRIEF DESCRIPTION OF THE DRAWINGS

FIG. 1 is a configuration diagram illustrating a system for capturing of the multi-channel image signal according to the preferred embodiment of the present invention.

FIG. 2 to FIG. 4 are drawings for explaining one example of deciding the unstable period of a decision module and selecting the sync signal of a second image signal thereby according to the present invention.

FIG. 5 is a drawing for explaining capturing rate of an image signal capturing system according to the present invention.

FIG. 6 is a drawing for explaining one example of decision of capturing order according to the present invention.

FIG. 7 is a flowchart specifically illustrating a method for capturing of the multi-channel image signal according to the preferred embodiment of the present invention.

FIG. 8 is an internal block diagram of a general-purpose computer which can be more adopted in implementing a method for capturing of the multi-channel image signal according to the present invention.

### BEST MODE FOR CARRYING OUT THE INVENTION

Hereinafter, a system and method for capturing of the multi-channel image signal according to the present invention will be described in detail with reference to the accompanying drawings.

Herein, a capturing order can mean an order to capture predetermined sync video data of a specific analog image signal and then transmit the captured sync video data to a post-processing device for storage or indication thereof in receiving at least one image signal, wherein a first image signal can be an image signal including video data captured according to the aforementioned capturing order and a second image signal can be the next image signal including video data to be captured after transmitting video data of the first image signal according to the capturing order.

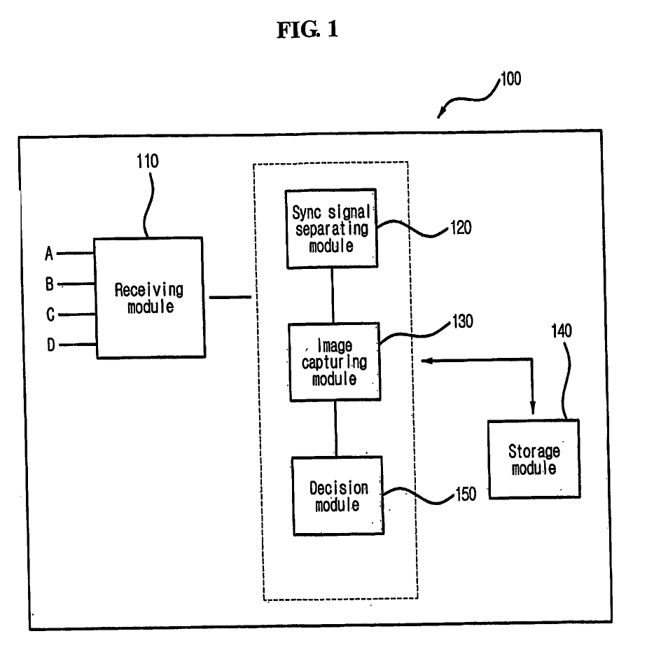

FIG. 1 is a configuration diagram showing a system for capturing of the multi-channel image signal according to the preferred embodiment of the present invention.

The system for capturing of the multi-channel image signal 100 of the present invention comprises a receiving module 110, a sync signal separating module 120, a storage module 140, and a decision module 150.

First, the receiving module 110 has functions of receiving an analog image signal from at least one camera (not shown) and outputting only one image signal selected by a predetermined criterion into the latter part. That is, the receiving module 110 can be a multiplexer for outputting the selected input signal among majority of input signals, for example, in case the receiving module 110 is a (4×1) multiplexer, the module 110 can control only one image signal among four input image signals to be output as shown in FIG. 1.

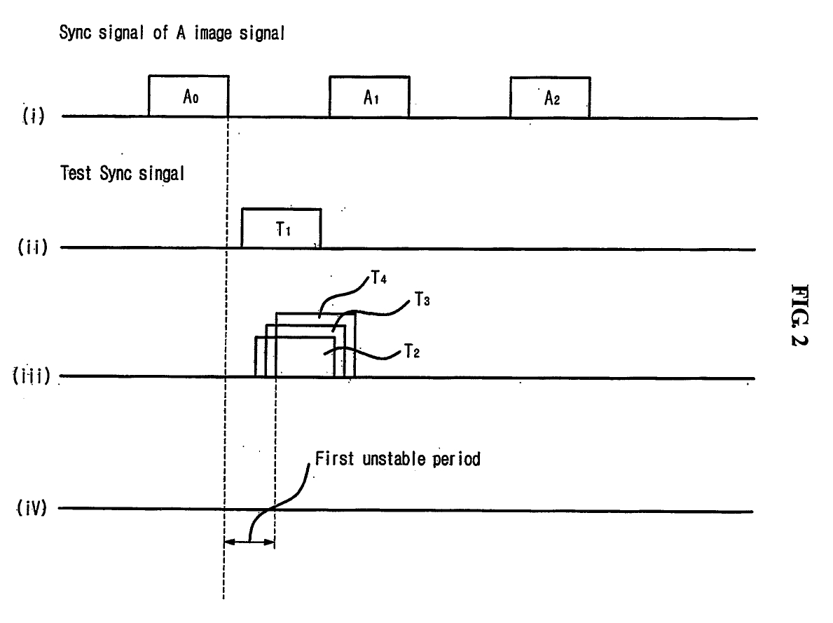

The sync signal separating module 120 includes a video sync separator circuit and is a device for extracting a sync signal from the image signal output from the receiving module 110. Herein, the sync signal is a standard signal for according timing with a transmitting side (a camera) in restoring the generated image signal in a camera to the original image, and the sync signal is classified into a vertical sync signal and a horizontal sync signal. The vertical sync signal includes information about starting point (rising edge) and ending point (falling edge) where video data included in an image signal are located and the horizontal sync signal includes information about duration that video data exist. Accordingly, the sync signal separating module 120 can prepare a timing diagram about video data of the image signal as shown in (i) of FIG. 2. The sync signal can be used as data for deciding the unstable period of the image capturing module 130 and information about the sync signal is stored in the following storage module 140. The unstable period is a period for which the image capturing module 130 is waiting for capturing video data of the next image signal (a second image signal) after capturing specific sync video data. Decision of the unstable period and detailed description thereof will be described later.

Further, the sync signal separating module 120 extracts a sync signal from an image signal input every predetermined period respectively, which is for correcting a minutely changed sync signal. That is, the period of a sync signal can be changed continuously in case of generation of each image signal, e.g., according to the photographing conditions. Therefore, the sync signal separating module 120 corrects the difference thereof and then reflects the corrected difference in the period of the sync signal. Accordingly, there may be an effect that the sync signal according to the present invention enables the following decision module 150 to decide the unstable period more exactly by making it possible to yield the exact period of a sync signal through continuous updating.

The image capturing module 130 captures specific sync video data of the same kind or other kind of an image signal according to a predetermined capturing order and transmits the captured sync video data to a predetermined display device or image storage device. Also, the image capturing module 130 functions as an A/D converter which converts captured analog video data into digital video data and the module 130 enables consecutive image signals to be replayed or stored by transmitting image signals of the same kind though the same route.

The storage module 140 is a storage medium recording information about the unstable period of the image capturing module 130 related to the extracted sync signal. Also, the storage module 140 can store and maintain information about an order that the image capturing module 130 captures video data of an image signal. There can be various types of the capturing order such as for example, a fixed type that a user decides the order by giving predetermined weight according to importance of a camera location (ex: A→B→C→A→B→C), or a changing type that the capturing order of video data is decided according to a certain criterion selected by a predetermined order decision algorism. For an example of the changing type, there may be a case that the system for capturing of the multi-channel image signal 100 decides an image signal corresponding to the nearest-approaching sync signal as a second image signal after capturing video data of a first image signal.

The decision module 150 decides the unstable period of the image capturing module 130 and selects the sync signal of a second image signal located outside of the unstable period decided according to the capturing order. The decision module 150 will be described by way of processes of deciding the unstable period and selecting the sync signal of the second image signal according to the decision with reference to FIG. 2 to FIG. 4.

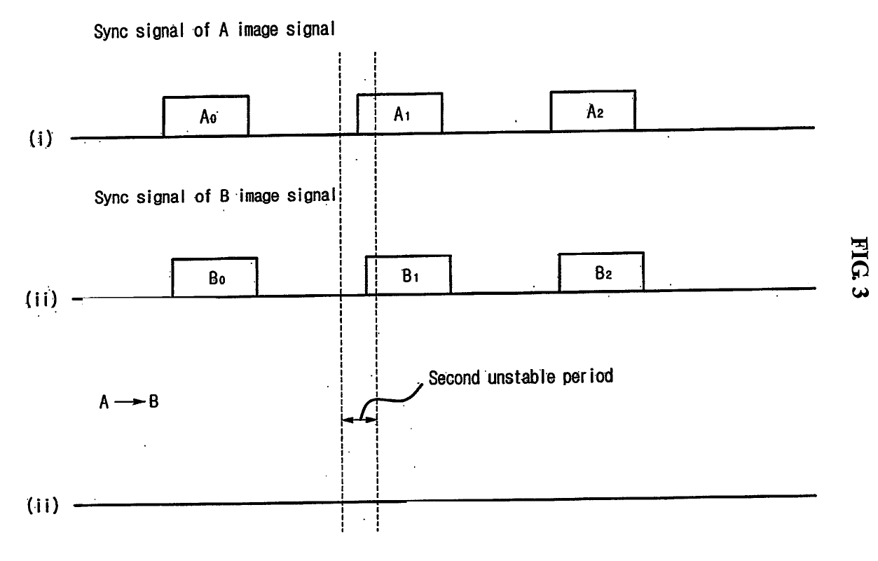

As aforementioned, the unstable period can be a period for which the image capturing module 130 is waiting without capturing the next image signal (a second image signal) after capturing a first image signal. As shown in FIG. 2 and FIG. 3, the unstable period of a predetermined period can exist respectively based on the falling edge of the sync signal (A0) of a first image signal and on the rising edge of the sync signal (A1) of the first image signal. Accordingly, in the present embodiment, it is noted that the unstable period output based on the falling edge of the sync signal (A0) is a first unstable period and the unstable period output based on the rising edge of the sync signal (A1) is a second unstable period. This first and second unstable period is manufacturing characteristics of the image capturing module 130, hereinafter how the decision module 150 decides the first and second unstable period will be described.

FIG. 2 is a timing diagram for explaining decision of the first unstable period.

First, in deciding the first unstable period, the sync signal separating module 120 extracts sync signals (a sync signal A0, a sync signal A1 . . . ) from A image signal of A camera and then prepares a timing diagram of sync signals as shown in (i) of FIG. 2.

Thereafter, the image capturing module 130 captures video data corresponding to the sync signal A0 and the decision module 150 inputs a test sync signal as shown in (ii) of FIG. 2 into the image capturing module 130 after predetermined time passes from the falling edge of the sync signal A0 (a first step). At this time, it is preferable that the decision module 150 controls the test sync signal to be generated for the minimum time from the falling edge of the sync signal A0, wherein this is in order to measure the extremely short unstable period exactly.

After input of the test sync signal, it is decided whether the image capturing module 130 recognizes the test sync signal (a second step). The step (the second step) is a process for deciding whether video data of the next image are in the capturable state if the image capturing module 130 recognizes the test sync signal.

If the image capturing module 130 does not recognize the test sync signal, the decision module 150 decides that the image capturing module 130 is in the unstable state and repeats the aforementioned first step and second step with increasing the input time of the test sync signal gradually (a third step). This step (the third step) is a process for making the test sync signal having input time difference as shown in (iii) of FIG. 2 enter the image capturing module 130 in order to decide the unstable period of the image capturing module 130 exactly. At this time, it is preferable to minimize input time difference as much as possible, whereby it is possible to know exactly a temporal location at which the first unstable period of the image capturing module 130 ends.

In the meantime, in case the image capturing module 130 recognizes the test sync signal according to increase of input time of the test sync signal, the decision module 150 decides the time when the relevant test sync signal is input as an ending point of the first unstable period. That is, as shown in (iv) of FIG. 2, in case the test sync signal recognized by the image capturing module 130, for example, is a test sync signal T4, the decision module 150 can decide the interval between the falling edge of the sync signal A0 and the rising edge of the test sync signal T4 as the first unstable period. At this time, the term ‘recognize’ in that the image capturing module 130 ‘recognizes’ the test sync signal implies that the module 130 not only knows the fact of occurrence of the test sync signal, but also ‘can capture exactly’ video data related to the test sync signal.

Accordingly, there can be an effect that the first unstable period that might have difference due to the manufacturing characteristics of the image capturing module 130 is exactly decided by the decision module 150.

FIG. 3 is a timing diagram for explaining decision of the second unstable period.

First, in deciding the second unstable period, the sync signal separating module 120 extracts sync signals from A image signal of A camera and sync signals from B image signal from B camera and then prepares a timing diagram of sync signals as shown in (i) and (ii) of FIG. 3. At this time, it is supposed that the image capturing module 130 captures video data corresponding to the sync signal A0 and then captures B image signal according to a predetermined capturing order (A→B).

The image capturing module 130 captures the sync signal A0 and then captures the specific sync signal of B image signal, that is a sync signal B1 according to the capturing order. At this time, as shown in (i) and (ii) of FIG. 3, in case the rising edge of the sync signal A1 of A image signal and the rising edge of the sync signal B1 of B image signal are close in aspect of time, there happens an error that the image capturing module 130 decides the captured sync signal B1 as the sync signal A1. That is, the image capturing module 130 decides that the sync signal A1 will be generated in a predetermined sequential period based on the rising edge of the sync signal A1, the next sync signal of the sync signal A0, with reference to the timing diagram of A image signal. In order to prevent the error thereof, the decision module 150 controls the image capturing module 130 to be in the unstable state by deciding the sequential period based on the rising edge of the sync signal A1 where the image capturing module 130 makes an error as the second unstable period. At this time, it is to set that a first point of time is a predetermined period before the rising edge of the next sync signal of the first sync signal and that a second point of time is a predetermined period thereafter. Therefore, it is possible to decide the period from the first point of time to the second point of time as the second unstable period. That is, the second unstable period is effected by a temporal location of the sync signal of the first image signal and the next sync signal of the first image signal.

For example, in case the image capturing module 130 is a video decoder chip BT878, the decision module 150 decides the former −32 horizontal sync period as the first point of time and the post +32 horizontal sync period as the second point of time based on the rising edge of the sync signal A1 as shown in (iii) of FIG. 3. That is, the decision module 150 can decide a 64 horizontal sync period as the second unstable period based on the rising edge of the sync signal A1 of (i) of FIG. 3.

Accordingly, although the image capturing module 130 tries to capture video data corresponding to the sync signal B1 according to capturing order, the module 130 skips the sync signal B1 since the module 130 is in the second unstable period and captures video data corresponding to the sync signal B2. Herein, BT878 implements function of a decoder by capturing an image signal. And BT878 embeds a buffer for storing video data inside and a DMA for rapidly transmitting video data to a memory means.

It has been experimentally proven that this second unstable period is applied to sync signals of all image signals under the same image capturing module 130. That is, the second unstable period of the sync signal A0 exists identically or similarly based on the rising edge of all sync signals recognized by the same image capturing module 130.

Accordingly, there can be an effect that the image capturing module 130 can capture only video data corresponding to a sync signal in more stable state by including the first unstable period and the second unstable period based on the captured sync signal.

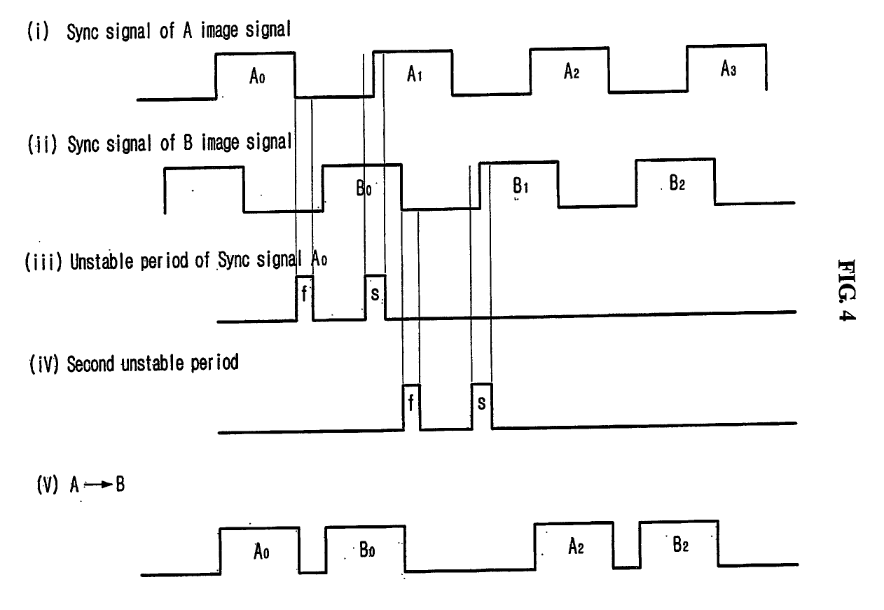

FIG. 4 is a timing diagram for explaining an example of selecting sync signals of a second image signal according to the present invention.

The capturing order in FIG. 4 considers that video data of specific sync of B image signal are captured after video data of specific sync of A image signal are captured.

FIG. 4 indicates the first unstable period (f: see FIG. 2) and the second unstable period (s: see FIG. 3) according to the specific sync signal recognized by the image capturing module 130 as temporal locations.

For example, as shown (i) and (ii) of FIG. 4, in case the sync signal of A image signal and the sync signal of B image signal are input, firstly, the image capturing module 130 recognizes the sync signal A0 of A image signal according to the capturing order and captures the relevant video data. At this time, it is possible to indicate the first unstable period (f) and the second unstable period (s) by the sync signal A0 as a predetermined period respectively, based on the falling edge of the sync signal A0 and the rising edge of the sync signal A1 as shown in (iii) of FIG. 4

Hereafter, the decision module 150 decides the sync signal of B image signal not having the rising edge within the first unstable period (f) and the second unstable period (s) of the sync signal A0, i.e., the sync signal B0 as the sync signal (that is, the relevant sync signal of video data to be captured) of the second image signal. Accordingly, the image capturing module 130 captures video data corresponding to the sync signal B0.

As aforementioned, it is possible to indicate the first unstable period (f) and the second unstable period (s) by the sync signal B0 as (iv) of FIG. 4. Likewise, it is possible to decide the sync signal A2 as the sync signal of the second image signal through the process of deciding the sync signal of the second image signal according to the decision module 150.

Accordingly, in the present embodiment, the image capturing module 130 of the present invention captures video data corresponding respectively according to the capturing order as shown in (vi) of FIG. 4, i.e., in order of sync signal A0→sync signal B0→sync signal A2 . . . .

Accordingly, there can be an effect that it is possible to capture video data of an image signal having an improved frame rate, wherein the decision module 150 can capture sync signals of the second image signal by recognizing sync signals exactly located outside of the unstable period and controls the image capture module 130 to be able to capture video data of the sync signal of the selected second image signal.

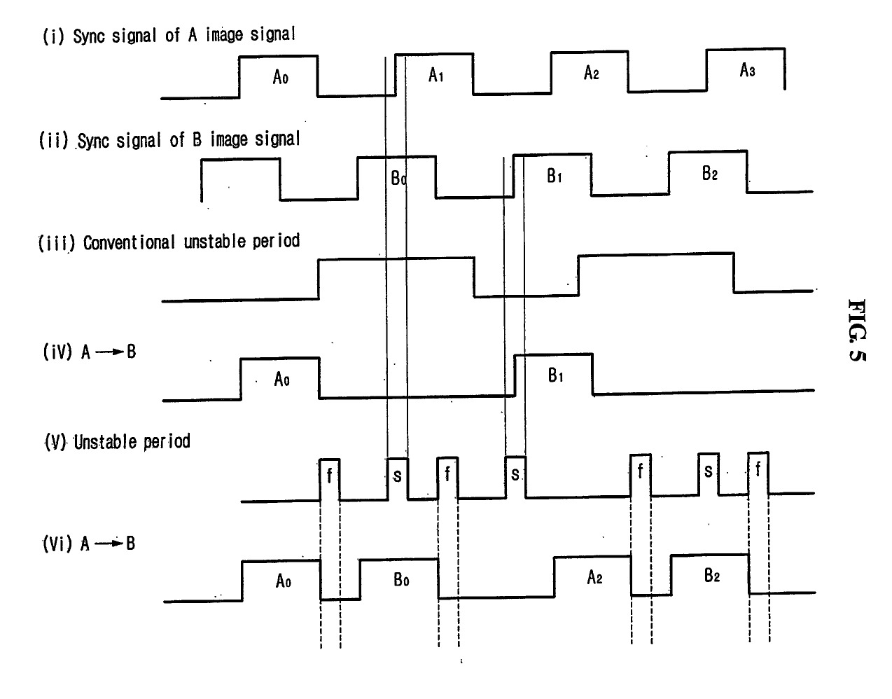

Hereinafter, it will be explained that the capturing rate of image signals is improved according to the image signal capturing system 100 of the present invention in comparison with the prior art with reference to FIG. 5.

FIG. 5 is a drawing for explaining capturing rate of image signals of the image signal capturing system 100 according to the present invention.

In FIG. 5, it is supposed that capturing order is A image signal→B image signal as aforementioned for the convenient understanding.

A timing diagram can be prepared as shown in (i) and (ii) of FIG. 5 by extracting each sync signal corresponding to A image signal and B image signal through the sync signal separating module 120.

(iii) of FIG. 5 shows the conventional unstable section, i.e., the unstable period of the image capturing module 130, wherein the conventional unstable period has been decided at his disposal by a predetermined user (for example, according to the use experience of the image capturing module 130) through estimation about sync signals of about 1 or 2 period, without the correct confirmation about the actual unstable period. That is, in case the image capturing module 130 captures video data corresponding to sync signal A0, the unstable period is decided by supposing period from falling edge of sync signal A0 to falling edge of sync signal A1 (1 period). Accordingly, an image signal capturing operation of the image capturing module 130 according to capturing order is to capture video data corresponding to sync signal B1 after capturing video data of sync signal A0, as shown in (iv) of FIG. 5. That is, the conventional image capturing module 130 does not implement an image signal capturing operation for sync signal B0.

On the other hand, (v) of FIG. 5 is a timing diagram showing the unstable period of the image capturing module 130 according to the present invention, wherein the decision module 150 decides the unstable period of the image capturing module 130 exactly considering the first unstable period (f) and the second unstable period (s). Accordingly, the unstable period of (v) of FIG. 5 is reduced remarkably in comparison to the unstable period of (iii) of FIG. 5, whereby the rate that the image capturing module 130 recognizes sync signals increases. That is, the image capturing module 130 captures video data corresponding in order of sync signal A0→sync signal B0→sync signal A2→sync signal B2, etc according to an image signal capturing operation.

Accordingly, there is an evident tendency that the image signal capturing rate of the present invention has improved by capturing about 2 video data on the same time line compared with the conventional image signal capturing rate, whereby it is to implement the object of the present invention improving image signal capturing rate substantially.

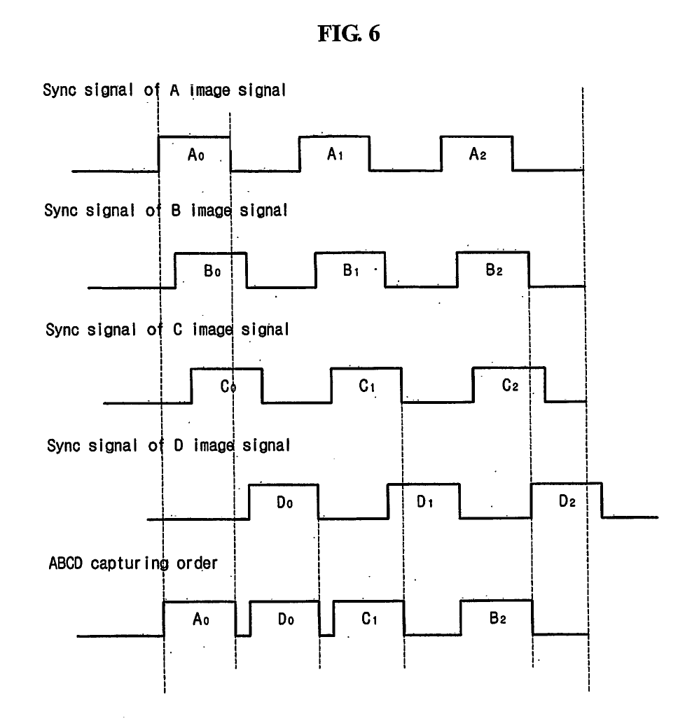

Hereinafter, decision of capturing order of the image capturing module 130 will be described with reference to FIG. 6.

FIG. 6 is a drawing for explaining an example of decision of capturing order according to the present invention.

In capturing order of the present invention, it is possible to establish a specific capturing order according to a predetermined user, or to determine the capturing order according to a predetermined order decision algorism.

First, in case of deciding the capturing order according to a user, it is possible to be made by the user's optional decision, for example, by giving weight to a camera on the sending side where an image signal is generated. This decision is mainly made in case that it is necessary to receive image signals more frequently than other image signals for high resolution of the specific image signal. Therefore, there may be provided a predetermined capturing order deciding user interface for a user. For example, it is possible to have image signals of a bank more received among A image signal generated in the bank and B image signal generated in a general office by establishing the capturing order in A→A→B→A→A→B, since the bank is generally more important. Although the present invention is described by way of decision of the capturing order by giving weight according to importance thereof, it is not defined thereto. There can be various examples of capturing order decision according to a user's decision.

Furthermore, in determining the capturing order according to order decision algorism, for example, there may be to decide the capturing order according to the relative starting time of other sync signal based on one specified sync signal. As shown in FIG. 6, there is supposed the system for capturing of the multi-channel image signal 100 input by sync signals of A image signal to sync signals of D image signal. The system for capturing of the multi-channel image signal 100 establishes sync signal A0 of the first A image signal as a standard signal according to order decision algorism, and sets the relative starting time of sync signal A0 as ‘0’. Also, it is that the relative starting time for sync signals of B image signal to D image signal is more than the relative starting time of the standard signal. Accordingly, the image capturing module 130 captures video data of sync signal A0 being a standard signal, and then captures the relevant video data by recognizing the nearest approaching sync signal D0 after falling edge of sync signal A0 in aspect of time. Thereafter, order decision algorism resets sync signal D0 as a standard signal ‘0’ and decides sync signal C1 having the minimal relative time based thereon as the next sync signal. Therefore, it is possible to determine the capturing order according to order decision algorism. Consequently, the system for capturing of the multi-channel image signal 100 according to the present embodiment not only can improve capturing rate of image signals, but also can determine the most efficient capturing order.

Furthermore, although decision of the capturing order according to order decision algorism of the present embodiment has been described by way of an example that the nearest approaching sync signal to falling edge of the captured sync signal is decided as the next sync signal, this is for convenient explanations. Therefore, it is also possible to analogize various types of order decision algorism, e.g., order decision algorism deciding the nearest approaching sync signal occurring outside of the unstable period as the next sync signal by considering the unstable period of the image capturing module 130, through technical spirits of the present invention.

The present invention will be in detail described about an operation flow of the system for capturing of the multi-channel image signal 100.

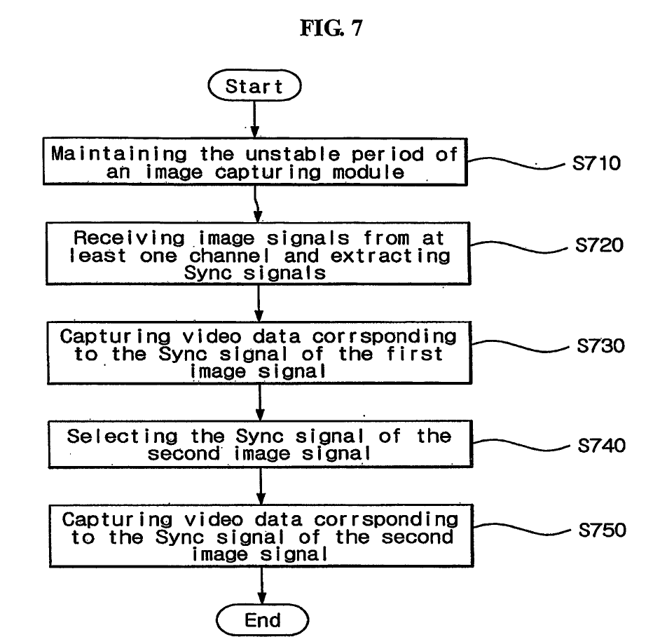

FIG. 7 is a flowchart of an operation illustrating a method for capturing of the multi-channel image signal according to the preferred embodiment of the present invention specifically.

The image signal capturing method according to the present embodiment is implemented by the system for capturing of the multi-channel image signal 100.

First, the system for capturing of the multi-channel image signal 100 maintains the unstable period of the image capturing module 130 in the predetermined storage module 140 (S710). This step (S710) is a process for deciding the first unstable period and the second unstable period through the decision module 150 and then storing the information in the storage module 140. As aforementioned, for example, in case of the first unstable period, it is possible to decide the first unstable period by letting a test sync signal having predetermined time difference based on falling edge of the captured sync signal enter (see FIG. 2) and in case of the second unstable period, it is possible to decide a predetermined sequence period (e.g., if BT878, 64 horizontal sync period) from rising edge of the next sync signal for the captured sync signal (see FIG. 3).

Furthermore, the system for capturing of the multi-channel image signal 100 receives image signals from at least one channel and extracts each sync signal from the received image signals (S720). This step (S720) is a process for receiving at least one image signal through the receiving module 110 and outputting only one image signal among received image signals into the latter part according to the selected criteria of the receiving module 110. Herein, a channel may mean a communication route which enables an image signal to be transmitted by linking the image capturing module 130 with a camera generating an image signal, for example, the channel may mean a frequency band or a frequency assigned to transmission of each image signal. Also, this step (S720) extracts sync signals indicating the area where video data of received analog image signals exist. Analog image signals comprise a large number of frames, wherein one frame comprises the blanking area and the active video area according to whether or not video data are included. That is, sync signals indicate the starting time, the ending time and duration of the active video area including video data, and it is possible to prepare a timing diagram of sync signals comprising vertical sync signals and horizontal sync signals.

The system for capturing of the multi-channel image signal 100 captures video data corresponding to the sync signal of the first image signal according to a predetermined capturing order (S730). This step (S730) is a process for recognizing the sync signal of the first image signal and capturing video data corresponding thereto through the image capturing module 130.

Furthermore, the system for capturing of the multi-channel image signal 100 selects the sync signal of the second image signal based on falling edge of the sync signal of the first image signal (S540). This step (S540) is a process for selecting the sync signal of the second image signal to be captured after the first image signal through the decision module 150. That is, the decision module 150 selects a sync signal not having rising edge within the first unstable period and the second unstable period of the sync signal of the captured first image signal as the sync signal of the second image signal based on capturing order. The explanation related thereto has been already aforementioned (see FIG. 4).

The system for capturing of the multi-channel image signal 100 captures video data corresponding to the sync signal of the second image signal (S750).

Accordingly, the method for capturing of the multi-channel image signal according to the present embodiment decides the unstable period of an image signal exactly whereby there is no more optional decision about the unstable period. Therefore, there can be an advantage that it is possible to improve capturing rate of image signals by making it possible to capture video data of the existing uncapturable image signal.

The embodiments of the present invention include computer readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

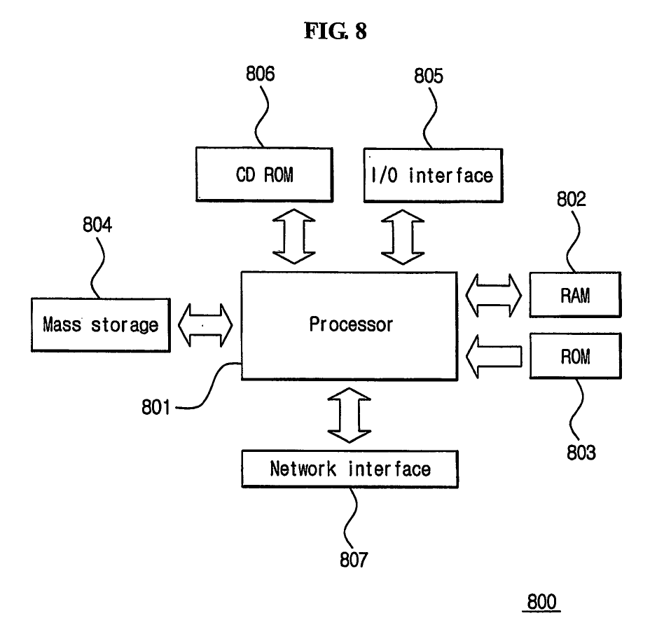

FIG. 8 is an internal block diagram of a general-purpose computer which can be more adopted in implementing the method for capturing of the multi-channel image signal according to the present invention.

The computer system 800 includes any number of processors 810 (also referred to as central processing units, or CPUs) that are coupled to storage devices including primary storage (typically a random access memory, or “RAM 820”), primary storage (typically a read only memory, or “ROM 830”). As is well known in the art, ROM 830 acts to transfer data and instructions uni-directionally to the CPU and RAM 820 is used typically to transfer data and instructions in a bi-directional manner. Both of these primary storage devices may include any suitable type of the computer-readable media described above. A mass storage device 840 is also coupled bi-directionally to CPU and provides additional data storage capacity and may include any of the computer-readable media described above. The mass storage device 840 may be used to store programs, data and the like and is typically a secondary storage medium such as a hard disk that is slower than primary storage. A specific mass storage device such as a CD-ROM 860 may also pass data uni-directionally to the CPU. Processor 810 is also coupled to an interface 850 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 810 optionally may be coupled to a computer or telecommunications network using a network connection as shown generally at 870. With such a network connection, it is contemplated that the CPU might receive information from the network, or might output information to the network in the course of performing the above-described method steps. The above-described devices and materials will be familiar to those of skill in the computer hardware and software arts.

The hardware elements above may be configured to act as one or more software modules for implementing the operations of this invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

### INDUSTRIAL APPLICABILITY

According to the present invention, it can be provided a system and a method for capturing of the multi-channel image signal which can enhance the capture efficiency by raising the rate of capturable video data to the maximum by deciding the unstable period of an image capturing module capturing video data of an image signal.

Furthermore, according to the present invention, it can be provided a system and a method for capturing of the multi-channel image signal which can capture video data corresponding to a sync signal under more stable state by deciding the first unstable period and the second unstable period in detail based on sync signals captured by an image capturing module and by enabling sync signals only occurring outside of the first unstable period and the second unstable period to be recognized by the image signal module.

Furthermore, according to the present invention, it can be provided a system and a method for capturing of the multi-channel image signal which can reduce loss of video data by determining the optimal capturing order by making it possible to yield the exact period of the sync signal through periodical updating for the sync signal of each image signal.

1. A system for capturing of the multi-channel image signal, the system comprising:
a receiving module for receiving image signals including video data from at least one camera;
a sync signal separating module for extracting sync signals indicating the existing location of video data from the image signal;
an image capturing module for capturing video data of the image signal sequentially according to a predetermined capturing order wherein an image signal captured according to the capturing order is a first image signal and an image signal to be captured after the first image signal is a second image signal;
a storage module for storing information about the unstable period of the image capturing module and the extracted sync signal respectively; and
a decision module for selecting the sync signal of the second image signal located outside of the unstable period based on the sync signal extracted from the first image signal and the unstable period; wherein
the unstable period includes the first unstable period, predetermined period from falling edge of the sync signal extracted from the first image signal.

2. The system as claimed in claim 1, wherein the first unstable period is decided by implementing the steps of:
a first step of inputting a test sync signal into the image capturing module after predetermined time elapses from the falling edge of the sync signal of the first image signal;
a second step of deciding whether the image capturing module recognizes the test sync signal;
a third step of repeating the first step and the second step with increasing the predetermined time until the test sync signal is recognized; and
a fourth step of deciding a period from the falling edge to the time at which the third step ends as the first unstable period.

3. The system as claimed in claim 1, wherein:
the unstable period further comprises the second unstable period from the first point of time before the rising edge of the next sync signal for the sync signal of the first image signal to the second point of time after the rising edge; wherein
the decision module selects the sync signal of the second image signal based on the first unstable period and the second unstable period.

4. The system as claimed in claim 3, wherein:
the decision module selects the sync signal of the second image signal having rising edge outside of the first unstable period and the second unstable period; wherein
the image capturing module captures video data of the second image signal corresponding to the selected sync signal.

5. The system as claimed in claim 1, wherein the predetermined capturing order is determined according to a user or predetermined order decision algorism.

6. The system as claimed in claim 6, wherein the sync signal separating module extracts sync signals from the image signal every predetermined period respectively.

7. A method for capturing of the multi-channel image signal, comprising the steps of:
maintaining information about the first unstable period and the second unstable period of an image capturing module in a predetermined storage module;
receiving image signals including video data from at least one channel and then extracting each sync signal from the received image signals respectively;
capturing the video data corresponding to a sync signal of a first image signal according to predetermined capturing order;
selecting a sync signal of a second image signal having rising edge outside of the first unstable period and the second unstable period based on falling edge of the sync signal of the first image signal; and
capturing the video data corresponding to the sync signal of the second image signal; wherein
the first unstable period is a predetermined period from falling edge of the sync signal extracted from the first image signal; and
the second unstable period is a period from the first point of time before rising edge of the next sync signal for the sync signal of the first image signal to the second point of time after rising edge.

8. A computer readable recording medium recording a program for implementing the method of claim 7.
